(19) United States
(12) Patent Application Publication
(10) Pub. No.: US 2018/0059409 A1
(43) Pub. Date: Mar. 1, 2018

(54) POLYGON MIRROR ASSEMBLY AND DETECTION APPARATUS USING POLYGON MIRROR ASSEMBLY

(71) Applicant: KOREA FOOD RESEARCH INSTITUTE, Seongnam-si (KR)

(72) Inventors: Sung Wook CHOI, HWASEONG-SI (KR); Min Ah WOO, YONGIN-SI (KR); Na Ri LEE, SEOUL (KR); Hyun Joo CHANG, SEOUL (KR); Gyeong Sik OK, OSAN-SI (KR)

(73) Assignee: KOREA FOOD RESEARCH INSTITUTE, Seongnam-si (KR)

(21) Appl. No.: 15/250,983

(22) Filed: Aug. 30, 2016

(51) Int. Cl. G02B 26/12; G02B 5/09; G02B 7/182; G01V 8/00

(52) U.S. Cl. CPC G02B 26/121; G02B 5/09; G01V 8/005; G02B 26/125; G02B 7/1821

(57) ABSTRACT

A polygon mirror assembly includes: a body including a coupled unit coupled to a shaft that is rotated; a plurality of first frames extended in a direction distant from the coupled unit; a plurality of reflection surfaces disposed between the first frames to form a polygon and rotatably coupled to the first frames; and driving units tilting the reflection surfaces.

### BACKGROUND

### Field

The present invention relates to a polygon mirror assembly capable of having a small size and a high resolution and obtaining a two-dimensional image at a high speed, and a detection apparatus using the same.

### Description of the Related Art

A millimeter wave or a tera-wave, which is a non-ionized electromagnetic wave, is usefully used to generate a non-destructive detection image of an inner portion of an object related to a living body requiring high stability. An image detection method may be divided into a passive method of directly measuring an electromagnetic wave generated from an object positioned at a long distance and an active method of irradiating an electromagnetic wave from a light source to an object and then measuring an electromagnetic wave reflected from or transmitted through the object, depending on whether or not the light source is used. Alternatively, the image detection method may also be divided depending on whether an array of detection elements is used or a single detection element is used. Among them, there is a method utilizing a single optical element and a scanning mirror as a method of generating an detection image having the highest signal to noise ratio (s/n ratio) using a light source having low power.

The millimeter wave or the tera-wave is mainly commercially used in a security image field. In the case of the millimeter wave or the tera-wave, a distance from an object to a lens is very long as compared with a wavelength of a light source, such that it is difficult to generate an image having a high resolution. However, this aspect is advantageous in that human rights of individuals are not violated, and the millimeter wave or the tera-wave is not harmful to a human body, the millimeter wave or the tera-wave is mainly used in a security image.

In addition, the millimeter wave or the tera-wave may be used in a field such as a food foreign material detection field or a quality monitoring field since it is relatively more stable than an X-ray with respect to a human body or a living body, in addition to the security image field. In order for the millimeter wave or the tera-wave to be used in the fields described above, a high resolution is necessarily required. In order to obtain an image having the high resolution, a method using a light source having a shorter wavelength is possible. However, as the wavelength becomes short, absorbance for moisture becomes larger, such that a signal to noise ratio (s/n ratio) becomes low. Therefore, in order to maintain the high resolution, there is a need to develop a technology of optically improving a resolution.

In order to raise the signal to noise ratio (s/n ratio), it is important to configure an image using a single detection element detecting a millimeter wave or a tera-wave from an object to be inspected while performing raster scanning using a lens focusing the millimeter wave or the tera-wave on one place and a mirror scanning the object to be inspected at a high speed. Here, in order to maintain the high resolution, it is required to increase a diameter (D) of a collimated beam incident to and entering a scanning mirror to increase f-number (f/D) when the beam is focused on a lens.

However, when the diameter of the beam is increased, sizes of optical components such as the mirror performing the scanning at the high speed are also increased. Therefore, a volume of an entire system is increased, and mobility is decreased. In addition, since at least two scanning tools should be connected to each other in parallel and be used in order to generate a two-dimensional image, there is a large spatial limitation.

In order to inspect an object or a material by a non-destructive method, an imaging method has been mainly used. Among them, two methods such as an image detection method using a continuous output light source and an image detection method using a spectroscopic method have been mainly used. These methods have advantages and disadvantages, respectively, but the image detection method using a continuous output light source has been more widely used in a field requiring a relatively high output, such as a transmission image.

Generally, when a resolution is improved, a depth of focus (DOF) is relatively decreased, and the related arts still have a limitation due to this problem.

Particularly, an optical system having a high resolution has a short depth of focus. Therefore, in order for the optical system having a high resolution to inspect an internal structure of an object having a predetermined volume by a non-destructive method, a focused point should be scanned even in a depth direction within the object to be inspected, which is troublesome. Due to this problem, much time is required in the case of generating a three-dimensional (3D) computerized tomography (CT) image on the basis of a projected absorption image, and when the scanning in the depth direction described above is omitted, a projection image of which an accuracy is significantly decreased is generated, such that quality of the image is deteriorated.

In addition, a detection resolution becomes high as a focal length of a lens becomes short. Therefore, in order to improve the resolution, the object to be inspected and the lens should be close to each other. Therefore, in this case, a working distance is significantly limited.

Meanwhile, as the related method for obtaining an image on a focal plane in real time, a method of obtaining an image directly using a focal plane array detector or a method of obtaining an image by combining a linear array detector or a single point detector and a scanning means with each other has been well known.

Particularly, among these methods, a method capable of performing high-sensitivity detection at a low cost while raising irradiation strength per unit area in order to most efficiently use energy of an incident electromagnetic wave is a method of focusing the incident electromagnetic wave on one point and detecting an electromagnetic wave reflected on or transmitted through a sample by the single point detector while changing a moving direction of the electromagnetic wave using high speed raster scanning (a polygon mirror, a galvano mirror, or the like).

However, most of electromagnetic wave beams used in this high speed raster scanning are focused in a Gaussian beam form, such that there is a large limitation in improving the resolution and the depth of focus as described above.

### SUMMARY

An object of the present invention is to provide a polygon mirror assembly capable of having a small size and a high resolution and obtaining a two-dimensional image at a high speed, and a detection apparatus using the same.

Other objects and advantages of the present invention may be understood by the following description and will be more clearly appreciated by exemplary embodiments of the present invention. In addition, it may be easily appreciated that objects and advantages of the present invention may be realized by means mentioned in the claims and a combination thereof.

According to an exemplary embodiment of the present invention, a polygon mirror assembly includes: a body including a coupled unit coupled to a shaft that is rotated; a plurality of first frames extended in a direction distant from the coupled unit; a plurality of reflection surfaces disposed between the first frames to form a polygon and rotatably coupled to the first frames; and driving units tilting the reflection surfaces.

The driving units may be individually coupled to the reflection surfaces, and independently tilt the reflection surfaces.

The driving units may be positioned between the coupled unit and the reflection surfaces.

The polygon mirror assembly may further include brackets disposed between adjacent first frames, wherein one side of the driving unit is coupled to the reflection surface, and the other side of the driving unit is coupled to the bracket.

The driving unit may be spaced apart from a rotation axis of the reflection surface, and be coupled to the reflection surface.

The polygon mirror assembly may further include second frames connecting adjacent first frames among the plurality of first frames to each other.

The second frames may be a pair of frames connecting the adjacent first frames to each other.

The reflection surface may be disposed between the pair of frames.

According to another exemplary embodiment of the present invention, a detection apparatus using a polygon mirror assembly includes: a light source generating an electromagnetic wave; the polygon mirror assembly including a plurality of reflection surfaces and reflecting the electromagnetic wave incident from the light source; and a detecting unit detecting strength of an electromagnetic wave generated from an object to be inspected by the electromagnetic wave reflected from the polygon mirror assembly.

The polygon mirror assembly may include: a body including a coupled unit coupled to a shaft that is rotated; a plurality of first frames extended in a direction distant from the coupled unit; a plurality of reflection surfaces disposed between the first frames to form a polygon and rotatably coupled to the first frames; and driving units tilting the reflection surfaces.

The driving units may be individually coupled to the reflection surfaces, and independently tilt the reflection surfaces.

The driving units may be positioned between the coupled unit and the reflection surfaces.

The polygon mirror assembly may further include brackets disposed between adjacent first frames, and one side of the driving unit may be coupled to the reflection surface and the other side of the driving unit may be coupled to the bracket.

The driving unit may be spaced apart from a rotation axis of the reflection surface, and be coupled to the reflection surface.

The polygon mirror assembly may further include second frames connecting adjacent first frames among the plurality of first frames to each other.

The second frames may be a pair of frames connecting the adjacent first frames to each other.

The reflection surface may be disposed between the pair of frames.

### BRIEF DESCRIPTION OF THE DRAWINGS

FIG. 1 is a perspective view for describing a polygon mirror assembly according to an exemplary embodiment of the present invention.

FIG. 2 is a plan view for describing the polygon mirror assembly according to an exemplary embodiment of the present invention.

FIGS. 3 to 5 are configuration views for describing two-dimensional scanning using the polygon mirror assembly according to an exemplary embodiment of the present invention.

FIG. 6 is a block diagram for describing a detection apparatus using a polygon mirror assembly according to an exemplary embodiment of the present invention.

FIG. 7 is a view for describing the detection apparatus using a polygon mirror assembly according to an exemplary embodiment of the present invention in detail.

### DETAILED DESCRIPTION

Hereinafter, detailed contents for embodying the present invention will be described in detail with reference to the accompanying drawings.

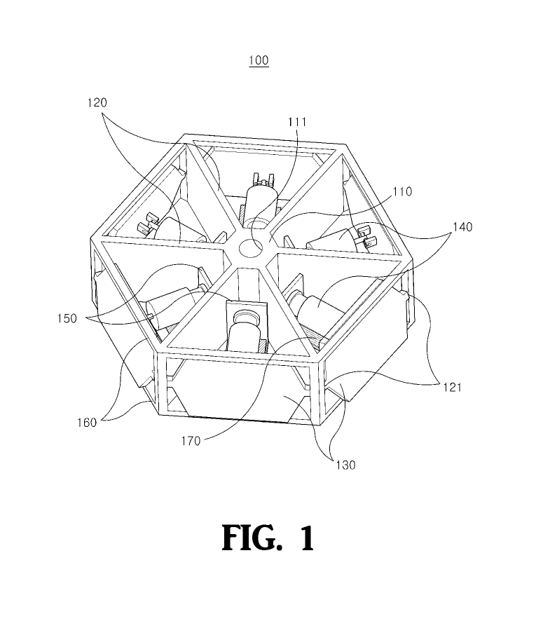

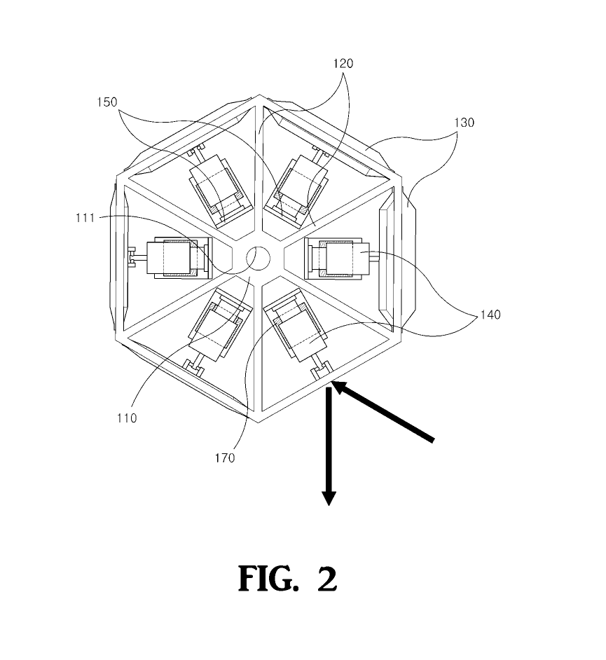

FIG. 1 is a perspective view for describing a polygon mirror assembly according to an exemplary embodiment of the present invention, and FIG. 2 is a plan view for describing the polygon mirror assembly according to an exemplary embodiment of the present invention.

Referring to FIGS. 1 and 2, the polygon mirror assembly 100 includes a body 110, first frames 120, reflection surfaces 130, driving units 140, brackets 150, second frames 160, and a control unit 170.

The body 110 may include a coupled unit 111 coupled to a shaft (not illustrated) that is rotated. The coupled unit 111 may have a space in which the shaft is accommodated. For example, the coupled unit 111 may have various forms that may be coupled to the shaft, such as a through-hole form, a groove form, and the like. The polygon mirror assembly 100 including the body 110 may be rotated together with the shaft as the shaft (not illustrated) is rotated.

The first frames 120 are extended in a direction distant from the body 110, and the number of first frames 120 may be plural. Although a case in which spaces are formed between the first frames 120 has been illustrated in FIG. 1, various forms such as a form in which some of the spaces between the first frames 120 are filled, a form in which upper surfaces or lower surfaces of the spaces formed by the first frames 120 are closed, and the like, are possible.

The first frame 120 may have hinge units 121 hinge-coupled to the reflection surfaces 130. The reflection surfaces 130 may be rotated by the driving units 140 in a state in which they are coupled to the hinge units 121.

The reflection surface 130 may reflect an electromagnetic wave incident thereto. For example, the reflection surface 130 may be a mirror.

In the present invention, the electromagnetic wave includes a millimeter wave or a tera-wave. The millimeter wave, which is an electromagnetic wave in an extremely high frequency band, preferably has a frequency of 30 GHz to 300 GHz. The tera-wave, which is an electromagnetic wave in a terahertz band, may preferably have a frequency of 0.1 THz to 10 THz. However, even though a tera-wave is slightly out of the range described above, this tera-wave may be considered as the tera-wave in the present invention when it is in a range that may be easily deduced by those skilled in the art to which the present invention pertains.

The reflection surfaces 130 may be disposed between the first frames 120, and be rotatably coupled to the first frames 120. The number of reflection surfaces 130 may be plural. Therefore, the polygon mirror assembly 100 may have a form of a plurality of reflection surfaces 130 constituting a polygon. Although a case in which the polygon mirror assembly 100 has a hexagonal form having six reflection surfaces 130 will be described in the present exemplary embodiment, the polygon mirror assembly 100 may have various forms such as quadrangular form, an octagonal form, and the like.

The driving units 140 may be coupled to the reflection surfaces 130, and may tilt the reflection surfaces 130. The driving units 140 may be various types of driving devices that may tilt the reflection surfaces 130.

A plurality of driving units 140 may be provided, and be individually coupled to the reflection surfaces 130. Therefore, in the case in which the number of reflection surfaces 130 is N, the number of driving units 140 may also be N. Therefore, the driving units 140 may independently tilt the reflection surfaces 130.

One driving unit 140 may be provided, and may be coupled to all the reflection surfaces 130 and tilt all the reflection surfaces 130.

The driving unit 140 may be positioned between the coupled unit 111 and the reflection surface 130.

The driving unit 140 may be spaced apart from a rotation axis of the reflection surface 130, and be coupled to the reflection surface 130. Therefore, even in the case in which the driving unit 140 is a device performing a linear motion, the driving unit 140 may tilt the reflection surface 130.

The brackets 150 may be disposed between adjacent first frames 120 among the first frames 120. In this case, one side of the driving unit 140 may be coupled to the reflection surface 130, and the other side of the driving unit 130 may be coupled to the bracket 150. Therefore, the driving unit 140 may be fixed into the polygon mirror assembly 100.

The second frames 160 may connect adjacent first frames 120 among the plurality of first frames 120 to each other. Therefore, the polygon mirror assembly 100 has a structure robust to rotation.

For example, the second frames 160 may be a pair of frames connecting the adjacent first frames 120 to each other. In this case, the reflection surface 130 may be disposed between the pair of frames. Therefore, damage to the reflection surface 130 due to external impact, or the like, may be prevented.

The control unit 170 may control the driving unit 140 to tilt the reflection surfaces 130 at set angles. For example, in the case in which the number of reflection surfaces 130 is two, the control unit 170 may control the driving unit 140 so that a first reflection surface is tilted by 10 degrees in a clockwise direction on the basis of a rotation axis of the polygon mirror assembly and control the driving unit 140 so that a second reflection surface is tilted by 20 degrees in the clockwise direction on the basis of the rotation axis of the polygon mirror assembly.

The angles set for the respective reflection surfaces may have a predetermined angle interval. For example, in the case in which the number of reflection surfaces is six, the respective reflection surfaces may be set at an interval of five degrees.

The control unit 170 may tilt the reflection surfaces 130 so as to be synchronized with a rotation speed of the polygon mirror assembly 100.

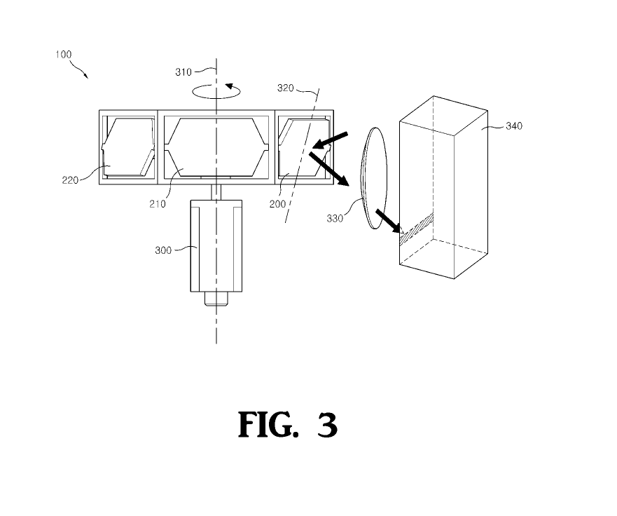

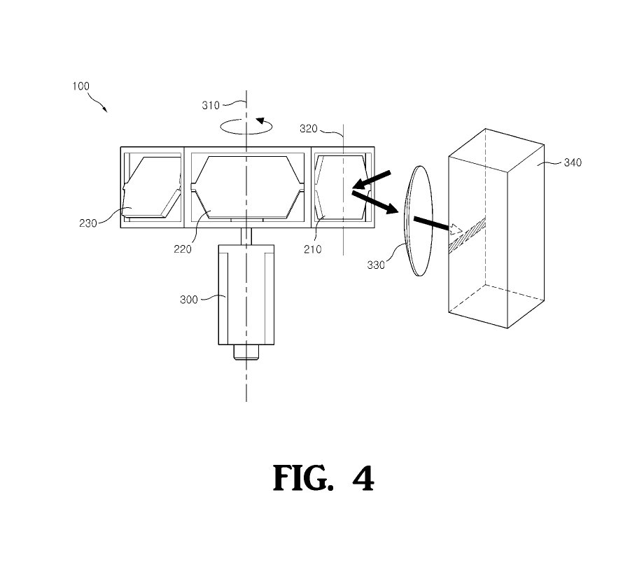

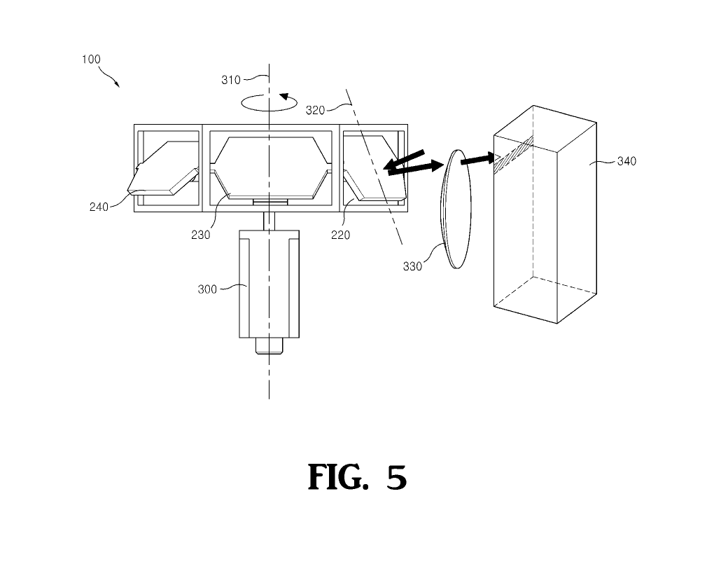

The control unit 170 may control the driving unit 140 so that the reflection surfaces 130 are sequentially tilted. For example, in the case in which the number of reflection surfaces 130 is four, the control unit 170 may control the driving unit 140 so that a first reflection surface is tilted by 10 degrees in a clockwise direction on the basis of the rotation axis of the polygon mirror assembly and control the driving unit 140 so that a second reflection surface is tilted by 20 degrees in the clockwise direction on the basis of the rotation axis of the polygon mirror assembly. In addition, the control unit 170 may control the driving unit 140 so that a third reflection surface is tilted by 30 degrees in the clockwise direction on the basis of the rotation axis of the polygon mirror assembly and control the driving unit 140 so that a fourth reflection surface is tilted by 40 degrees in the clockwise direction on the basis of the rotation axis of the polygon mirror assembly. As described above, the tilted angles of the reflection surfaces are controlled, thereby making it possible to change positions at which electromagnetic waves reflected on the reflection surfaces 130 are incident to an object to be inspected. Through this, the polygon mirror assembly 100 may allow the electromagnetic wave to be two-dimensionally incident to the object to be inspected. This will be described in detail below with reference to FIGS. 3 to 5.

The control unit 170 may control the driving unit 140 so that tilted angles of the respective reflection surfaces 130 are different from each other whenever the body 110 is rotated once. For example, in the case in which the number of reflection surfaces 130 is four, the control unit 170 may control the driving unit 140 so that a first reflection surface is tilted by 10 degrees in a clockwise direction on the basis of the rotation axis of the polygon mirror assembly and control the driving unit 140 so that a second reflection surface is tilted by 20 degrees in the clockwise direction on the basis of the rotation axis of the polygon mirror assembly, when the body 110 is rotated for the first time. In addition, the control unit 170 may control the driving unit 140 so that a third reflection surface is tilted by 30 degrees in the clockwise direction on the basis of the rotation axis of the polygon mirror assembly and control the driving unit 140 so that a fourth reflection surface is tilted by 40 degrees in the clockwise direction on the basis of the rotation axis of the polygon mirror assembly. The control unit 170 may control the driving unit 140 so that a first reflection surface is tilted by 5 degrees in a counterclockwise direction on the basis of the rotation axis of the polygon mirror assembly and control the driving unit 140 so that a second reflection surface is tilted by 15 degrees in the counterclockwise direction on the basis of the rotation axis of the polygon mirror assembly, when the body 110 is rotated for the second time. In addition, the control unit 170 may control the driving unit 140 so that a third reflection surface is tilted by 25 degrees in the counterclockwise direction on the basis of the rotation axis of the polygon mirror assembly and control the driving unit 140 so that a fourth reflection surface is tilted by 35 degrees in the counterclockwise direction on the basis of the rotation axis of the polygon mirror assembly.

The control unit 170 may control the driving unit 140 so that the reflection surfaces 130 are tilted in various schemes in addition to the scheme described above. The control unit 170 controls the driving unit 140 in consideration of a rotation speed of the polygon mirror assembly 100.

FIGS. 3 to 5 are configuration views for describing two-dimensional scanning using the polygon mirror assembly according to an exemplary embodiment of the present invention.

Referring to FIGS. 1 to 3, the coupled unit 111 of the polygon mirror assembly 100 may be coupled to a shaft coupled to a rotation driving unit 300. The polygon mirror assembly 100 is rotated around a rotation axis 310. In the present exemplary embodiment, the polygon mirror assembly 100 may include six reflection surfaces 200, 210, 220, 230, 240, and 250.

In the case in which a first reflection surface 200 is tilted by 10 degrees in the clockwise direction with respect to the rotation axis 310 (see reference numeral 320), an electromagnetic wave incident from a light source (not illustrated) is reflected on the first reflection surface 200, and the reflected electromagnetic wave is incident to an object 340 to be inspected through a focusing lens 330. In this case, the reflected electromagnetic wave may scan a lower end portion of the object 340 to be inspected.

Referring to FIGS. 1, 2, and 4, in the case in which a second reflection surface 210 is tilted in parallel with the rotation axis 310 (see reference numeral 320), an electromagnetic wave incident from a light source (not illustrated) is reflected on the second reflection surface 210, and the reflected electromagnetic wave is incident to an object 340 to be inspected through a focusing lens 330. In this case, the reflected electromagnetic wave may scan an intermediate end portion of the object 340 to be inspected.

Referring to FIGS. 1, 2, and 5, in the case in which a third reflection surface 220 is tilted by 10 degrees in the clockwise direction with respect to the rotation axis 310 (see reference numeral 320), an electromagnetic wave incident from a light source (not illustrated) is reflected on the third reflection surface 220, and the reflected electromagnetic wave is incident to an object 340 to be inspected through a focusing lens 330. In this case, the reflected electromagnetic wave may scan an upper end portion of the object 340 to be inspected. As described above, tilted angles of the reflection surfaces 200, 210, and 220 are adjusted to two-dimensionally scan the object 340 to be inspected.

The rotation driving unit 300 may rotate the shaft to rotate the polygon mirror assembly 100.

The angles of the reflection surfaces 200, 210, and 220 in the present exemplary embodiment are only examples, and may be various angles.

The polygon mirror assembly according to the present exemplary embodiment may include a plurality of reflection surfaces, and tilt the reflection surfaces using the driving unit, thereby two-dimensionally scanning the object to be inspected.

In addition, the polygon mirror assembly may tilt the plurality of reflection surfaces at various angles using the driving unit in a state in which it is rotated, thereby scanning the object to be inspected at a high speed.

Further, since devices for two-dimensionally scanning the object to be inspected are compactly included in the polygon mirror assembly, an entire size of the polygon mirror assembly may be decreased.

Further, in the polygon mirror assembly, the reflection surfaces, the driving unit, the control unit, and the like, are positioned in the frames, such that the reflection surfaces, the driving unit, the control unit, and the like, may be protected from external impact, or the like.

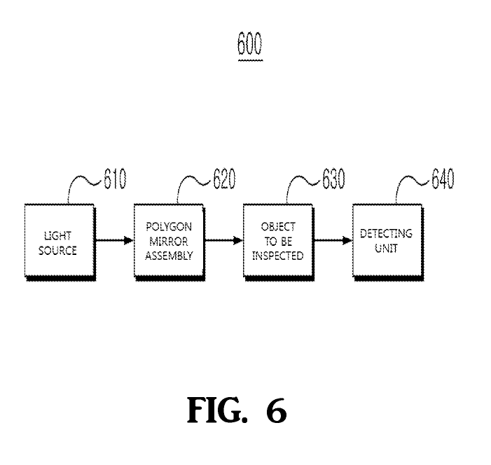

FIG. 6 is a block diagram for describing a detection apparatus using a polygon mirror assembly according to an exemplary embodiment of the present invention.

Referring to FIGS. 1 and 6, the detection apparatus 600 using a polygon mirror assembly includes a light source 610, the polygon mirror assembly 620, an object 630 to be inspected, and a detecting unit 640.

The light source 610 may be various types of devices that may generate an electromagnetic wave. For example, the light source 610 may generate a millimeter wave or a tera-wave. The millimeter wave, which is an electromagnetic wave in an extremely high frequency band, preferably has a frequency of 30 GHz to 300 GHz. The tera-wave, which is an electromagnetic wave in a terahertz band, may preferably have a frequency of 0.1 THz to 10 THz. However, even though a tera-wave is slightly out of the range described above, this tera-wave may be considered as the tera-wave in the present invention when it is in a range that may be easily deduced by those skilled in the art to which the present invention pertains.

The polygon mirror assembly 620 may include a plurality of reflection surfaces, and reflect the electromagnetic wave incident from the light source 610.

The polygon mirror assembly 620 includes a body, first frames, reflection surfaces, driving units, brackets, second frames, and a control unit. Since the body, the first frame, the reflection surface, the driving unit, the bracket, the second frame, and the control unit have been described above with reference to FIGS. 1 and 2, a detailed description therefor will be omitted.

The object 630 to be inspected means a target object to be inspected. The target object may be various types of objects such as a bag, a food, a cellular phone, and the like.

The detecting unit 640 may detect strength of an electromagnetic wave generated from the object 630 to be inspected by the electromagnetic wave reflected from the polygon mirror assembly 620. For example, the detecting unit 640 may detect strength of an electromagnetic wave reflected from the object 630 to be inspected, detect strength of an electromagnetic wave transmitted through the object 630 to be inspected, or be formed in the vicinity of the object 630 to be inspected to detect strength of a scattered electromagnetic wave.

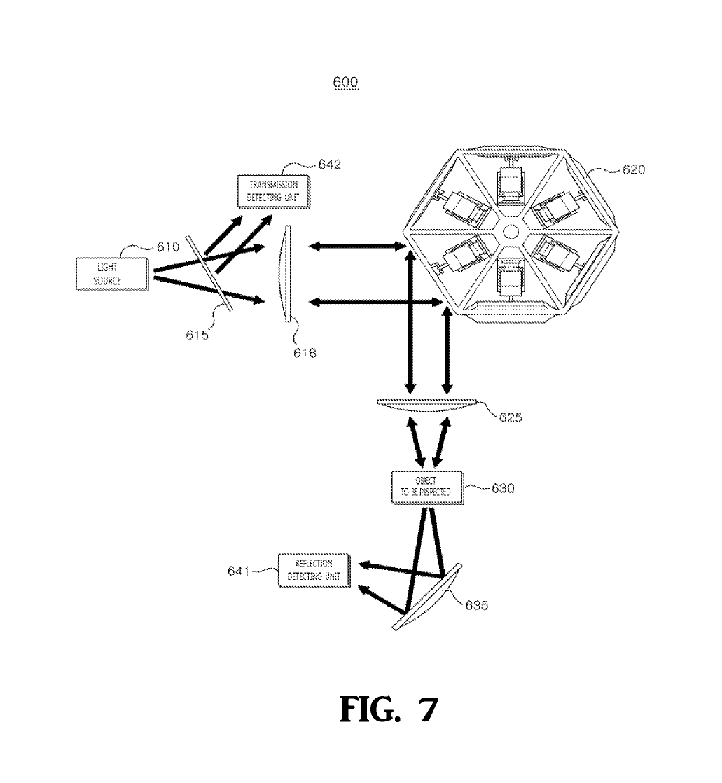

FIG. 7 is a view for describing the detection apparatus using a polygon mirror assembly according to an exemplary embodiment of the present invention in detail.

Referring to FIG. 7, the detection apparatus 600 using a polygon mirror assembly includes the light source 610, a beam splitter 615, a collimating unit 618, the polygon mirror assembly 620, a focusing lens 625, the object 630 to be inspected, a light collecting unit 635, a transmission detecting unit 641, and a reflection detecting unit 642.

The light source 610 may be various types of devices that may generate an electromagnetic wave. For example, the light source 610 may generate a millimeter wave or a tera-wave.

The beam splitter 615 may allow the electromagnetic wave incident from the light source 610 to be incident to the collimating unit 618.

In addition, the beam splitter 615 may reflect an electromagnetic wave reflected from the object 630 to be inspected and incident through the focusing lens 625, the polygon mirror assembly 620, and the collimating unit 618 to the reflection detecting unit 642.

The collimating unit 618 may collimate the electromagnetic wave incident from the beam splitter 615.

The polygon mirror assembly 620 may include a plurality of reflection surfaces, and reflect the electromagnetic wave incident from the collimating unit 618 to the focusing lens 625.

The polygon mirror assembly 620 includes a body, first frames, reflection surfaces, driving units, brackets, second frames, and a control unit. Since the body, the first frame, the reflection surface, the driving unit, the bracket, the second frame, and the control unit have been described above with reference to FIGS. 1 and 2, a detailed description therefor will be omitted.

The focusing lens 625 may focus the electromagnetic wave incident from the polygon mirror assembly 620 on the object 630 to be inspected.

The light collecting unit 635 may focus the electromagnetic wave transmitted through the object 630 to be inspected to the transmission detection unit 641.

The transmission detecting unit 641 may detect strength of the electromagnetic wave reflected from the light collecting unit 635.

The reflection detecting unit 642 may detect strength of the electromagnetic wave reflected from the beam splitter 615.

The detection apparatus using a polygon mirror assembly according to the present exemplary embodiment may include the plurality of reflection surfaces, and use the polygon mirror assembly that may tilt the reflection surfaces using the driving unit, thereby two-dimensionally scanning the object to be inspected.

In addition, the detection apparatus using a polygon mirror assembly may use the polygon mirror assembly that may tilt the plurality of reflection surfaces at various angles using the driving unit in a state in which it is rotated, thereby scanning the object to be inspected at a high speed.

Further, the detection apparatus using a polygon mirror assembly uses the polygon mirror assembly in which devices for two-dimensionally scanning the object to be inspected are compactly included, such that an entire size of the detection apparatus using a polygon mirror assembly may be minimized.

Further, in the polygon mirror assembly, the reflection surfaces, the driving unit, the control unit, and the like, are positioned in the frames, such that the reflection surfaces, the driving unit, the control unit, and the like, may be protected from external impact, or the like.

The polygon mirror assembly according to the present invention described above may include a plurality of reflection surfaces, and tilt the reflection surfaces using the driving unit, thereby two-dimensionally scanning the object to be inspected.

In addition, the polygon mirror assembly may tilt the plurality of reflection surfaces at various angles using the driving unit in a state in which it is rotated, thereby scanning the object to be inspected at a high speed.

Further, since two scanning tools for two-dimensionally scanning the object to be inspected are integrated with each other and included in one apparatus, an entire size of the apparatus may be decreased.

Further, since the two scanning tools for two-dimensionally scanning the object to be inspected are integrated with each other as one tool and miniaturized, a diameter of an incident beam may be increased as compared with in the case in which the two scanning tools are used, such that an image resolution may be improved.

Further, the reflection surfaces, the driving unit, the control unit, and the like, are positioned in the frames, such that the reflection surfaces, the driving unit, the control unit, and the like, may be protected from external impact, or the like.

All or some of the respective exemplary embodiments may be selectively combined with each other so that the above-mentioned exemplary embodiments may be variously modified.

In addition, it is to be noted that the exemplary embodiments are provided in order to describe the present invention rather than limiting the present invention. Further, those skilled in the art to which the present invention pertains may understand that various exemplary embodiments are possible without departing from the spirit and scope of the present invention.

What is claimed is:

1. A polygon mirror assembly comprising:
a body including a coupled unit coupled to a shaft that is rotated;
a plurality of first frames extended in a direction distant from the coupled unit;
a plurality of reflection surfaces disposed between the first frames to form a polygon and rotatably coupled to the first frames; and
driving units tilting the reflection surfaces.

2. The polygon mirror assembly of claim 1, wherein the driving units are positioned between the coupled unit and the reflection surfaces, are individually coupled to the reflection surfaces, and independently tilt the reflection surfaces.

3. The polygon mirror assembly of claim 2, further comprising brackets disposed between adjacent first frames,
wherein one side of the driving unit is coupled to the reflection surface, and the other side of the driving unit is coupled to the bracket.

4. The polygon mirror assembly of claim 1, wherein the driving unit is spaced apart from a rotation axis of the reflection surface, and is coupled to the reflection surface.

5. The polygon mirror assembly of claim 1, further comprising second frames connecting adjacent first frames among the plurality of first frames to each other.

6. The polygon mirror assembly of claim 5, wherein the second frames are a pair of frames connecting the adjacent first frames to each other, and
the reflection surface is disposed between the pair of frames.

7. The polygon mirror assembly of claim 1, wherein the first frame has a hinge unit hinge-coupled to the reflection surface.

8. The polygon mirror assembly of claim 1, further comprising a control unit controlling the driving unit to tilt the reflection surfaces at set angles.

9. The polygon mirror assembly of claim 8, wherein the control unit controls the driving unit so that tilted angles of the respective reflection surfaces are different from each other whenever the body is rotated once.

10. The polygon mirror assembly of claim 1, wherein the coupled unit has a space in which the shaft is accommodated.

11. A detection apparatus using a polygon mirror assembly, comprising:
a light source generating an electromagnetic wave;
the polygon mirror assembly including a plurality of reflection surfaces and reflecting the electromagnetic wave incident from the light source; and
a detecting unit detecting strength of an electromagnetic wave generated from an object to be inspected by the electromagnetic wave reflected from the polygon mirror assembly.

12. The detection apparatus using a polygon mirror assembly of claim 11, wherein the polygon mirror assembly includes:
a body including a coupled unit coupled to a shaft that is rotated;
a plurality of first frames extended in a direction distant from the coupled unit;
a plurality of reflection surfaces disposed between the first frames to form a polygon and rotatably coupled to the first frames; and
driving units tilting the reflection surfaces.

13. The detection apparatus using a polygon mirror assembly of claim 12, wherein the driving units are individually coupled to the reflection surfaces, and independently tilt the reflection surfaces.

14. The detection apparatus using a polygon mirror assembly of claim 12, wherein the driving units are positioned between the reflection surfaces and the coupled unit.

15. The detection apparatus using a polygon mirror assembly of claim 14, wherein the polygon mirror assembly further includes brackets disposed between adjacent first frames, and
one side of the driving unit is coupled to the reflection surface, and the other side of the driving unit is coupled to the bracket.

16. The detection apparatus using a polygon mirror assembly of claim 12, wherein the driving unit is spaced apart from a rotation axis of the reflection surface, and is coupled to the reflection surface.

17. The detection apparatus using a polygon mirror assembly of claim 12, wherein the polygon mirror assembly further includes second frames corresponding to a pair of frames connecting adjacent first frames to each other and connecting adjacent first frames among the plurality of first frames to each other.

18. The detection apparatus using a polygon mirror assembly of claim 17, wherein the reflection surface is disposed between the pair of frames.

19. The detection apparatus using a polygon mirror assembly of claim 12, wherein the first frame has a hinge unit hinge-coupled to the reflection surface.

20. The detection apparatus using a polygon mirror assembly of claim 12, wherein the coupled unit has a space in which the shaft is accommodated.

21. The detection apparatus using a polygon mirror assembly of claim 11, further comprising a collimating unit collimating the electromagnetic wave incident from the light source; and
a focusing lens focusing the electromagnet wave incident from the polygon mirror assembly on the object to be inspected,
wherein the polygon mirror assembly reflects the electromagnetic wave incident from the collimating unit.
